(19) United States
(12) Patent Application Publication
(10) Pub. No.: US 2007/0251828 A1
(43) Pub. Date: Nov. 1, 2007

(54) Gas Sparging

(75) Inventors: Phillip Ernest Grazier, Kilaben Bay (AU); David Rigby, Charlestown (AU); Alan David Stuart, New Lambton (AU)

Correspondence Address: MCKEE, VOORHEES & SEASE, P.L.C., 801 GRAND AVENUE, SUITE 3200, DES MOINES, IA, 50309-2721, US

(73) Assignee: BHP BILLITON INNOVATION PTY, VICTORIA (AU)

(21) Appl. No.: 10/569,120

(22) PCT Filed: Aug. 18, 2004
(86) PCT No.: PCT/AU04/01101

§ 371 Date: Sep. 29, 2006

(30) Foreign Application Priority Data
Aug. 22, 2003 (AU) 2003904575

(51) Int. Cl. C25D 3/38; B05B 7/00

(52) U.S. Cl. 205/291; 118/300

(57) ABSTRACT

The invention relates to a method for operating interacting different units, particularly of an installation, with different controllers that control these advanced control sequences, particularly with different control pulses. The inventive method is characterized in that the clock pulses (IPOᵢ) of the different controllers (3.1, 3.2, 3.3) are interpolated to a common system clock pulse (t_{Tiex}), and that the control sequences are synchronized. A device suited for carrying out the inventive method correspondingly comprises at least one common interpolation device (5.3) for the controllers (3.1, 3.2., 3.3) for interpolating the clock pulses (IPOᵢ) of the different controllers (3.1, 3.2, 3.3) to a common system clock pulse (t_{Tiex}) and at least one synchronization device (5) for synchronizing the control sequences.

This invention relates to gas sparging of electrolytic cells.

In electrolytic cell technology, it is known that the productivity of electrowinning of materials such as copper is proportional to the current density at which the electrodes in the cell operate. It is not normally practical, however, to simply increase the current density of a cell in order to lift its productivity because of the problem of removal of depleted electrolyte boundary layers which tend to form adjacent to the electrodes. In electrowinning of copper, removal of the depleted electrolytic boundary layer adjacent to the cathode is a particular problem. Various techniques have been proposed for addressing this problem including the provision of circulating systems for circulating fresh electrolyte so that it replaces the depleted electrolyte which builds up adjacent to the electrodes. It is also known to use a sparging gas to cause turbulence adjacent to the electrodes in order to break up boundary layers of depleted electrolyte which tend to form adjacent to the electrodes.

Where a sparging gas is to be used in a large scale industrial cell, it normally is introduced in the form of a series of rigid tubes or pipes which are provided with outlet orifices from which bubbles of the sparging gas can emerge. A delivery manifold is coupled to the pipes in order to supply the sparging gas at appropriate pressure and flow rate to the manifold to ensure that adequate sparging bubbles are produced. There are problems with the conventional arrangement. First, is the capital cost of the installation of the sparging equipment. Second, the sparging tubes are frequently made of PVC or other plastic material and can be damaged. Third, the outlet orifices can become clogged and this can cause problems of non-uniform distribution of sparging gas because the outlet orifices are typically specifically directed at a particular electrode plate or part thereof. The major problem, however, with sparging systems which have been proposed is that they exacerbate the problem of production of acid mist in the cell tankhouse. Acid mist causes corrosion problems and is a serious occupational health and safety issue for tankhouse workers. The disadvantages are such that sparging is not normally used routinely on a commercial scale because of the aforementioned disadvantages.

An object of the present invention is to provide a novel sparging apparatus and method which at least partially overcomes some of the problems in the prior art.

According to the present invention there is provided a method of operating an electrolytic cell including the steps of:

disposing sparging elements in electrolyte in the cell, the elements having a multiplicity of surface pores or openings therein; and

supplying sparging gas to the elements such that the elements form a multiplicity of fine sparging gas bubbles in the electrolyte.

The invention also provides a method of operating an electrolytic cell which includes a plurality of cathodes for deposition of copper thereon from an electrolyte in the cell, the method including the step of releasing sparging air bubbles beneath the cathodes characterised in that the majority of the air bubbles is in the size range from 1 mm to 3 mm.

The invention also provides a method of operating an electrolytic cell which includes a plurality of cathodes for deposition of copper thereon from an electrolyte in the cell, the method including the step of disposing a plurality of microporous hoses beneath the cathodes, supplying sparging gas to the hoses so that a zone of fine sparging gas bubbles is produced and permitting the fine sparging gas bubbles to rise in the electrolyte adjacent to the cathodes so that any depleted electrolyte adjacent to the cathodes is disturbed.

The invention also provides an apparatus for sparging an electrolytic cell, the apparatus including an inlet manifold to which a sparging gas is delivered, a plurality of hoses, and coupling means for coupling at least one end of each of the hoses to the manifold, characterised in that the hoses are made from or includes microporous material which permits, in use, the sparging gas to pass therethrough so as to form a multiplicity of fine bubbles in the electrolyte in the cell.

The invention also provides an apparatus for sparging an electrolytic cell, the apparatus including an inlet manifold to which a sparging gas is delivered, a plurality of sparging gas discharge elements, and coupling means for coupling at least one end of each of the elements to the manifold, characterised in that the elements are made from or includes microporous material which permits, in use, the sparging gas to pass therethrough so as to form a multiplicity of fine bubbles in the electrolyte in the cell.

The invention also provides an electrolytic cell for electrowinning of copper, the cell including:

a plurality of alternately disposed anode and cathode plates in the cell;

an electrolyte containing copper ions in the cell;

a sparging gas manifold located beneath the cathode plates;

sparging gas supply means for supplying sparging gas to said manifold; and

wherein the manifold includes microporous material which permits, in use, the sparging gas to pass therethrough so as to form a multiplicity of fine bubbles in the electrolyte.

In the method and apparatus of the invention, the majority of the bubbles of sparging gas are in the range from 1 mm to 3 mm in diameter. It will be appreciated that bubbles of this size are much smaller than those which have been proposed previously. The small size of the bubbles leads to a number of significant advantages. First, the small bubbles are effective in removing depleted electrolyte adjacent to the surfaces of the cathodes in order to permit fresh electrolyte to come into contact with the cathodes. Second, the small size of the bubbles tends to minimise the production of acid mist. In contrast, sparging systems with larger bubble sizes tend to significantly exacerbate the problem of acid mist. This is the case even in circumstances where measures are taken to suppress acid mist. For instance, one technique for suppressing acid mist is to use a hollow plastic ball to form a layer which floats on the surface of the electrolyte. Typically, these balls are in the range from 10 mm to 15 mm although some smaller balls are used which are of the order of say 5 mm in diameter. It is also known to use a surfactant to modify the surface tension at the surface of the electrolyte in order to reduce mist. One such surfactant is FC1100 supplied by 3M.

In the method and apparatus of the invention, the layer of balls and surfactant can also be used to suppress acid mist.

In sparging systems which use larger bubble sizes, it has been found that when the larger bubbles reach the surface of the electrolyte, there can be localised areas of turbulence which displace the balls in the layer leaving exposed areas of electrolyte. These exposed areas of electrolyte can contribute substantially to acid mist. In the method and apparatus of the invention, the fine bubbles tend to be more uniformly distributed in the cell and have a tendency not to produce any exposed areas of electrolyte when balls are used.

Another advantage of the method and apparatus of the invention is that if the microporous hoses are damaged and/or are worn out they can be easily replaced. This could be done without removing the sparging manifold from the cell or removing other cell infrastructure such as the electrolyte delivery manifold.

The use of microporous hoses results in a sparging system which is cheaper and easier to make than known sparging manifolds.

A still further advantage of the use of microporous hoses is that the fine bubbles are produced over a relatively wide area at the bottom of the cell and this avoids the need to accurately align discharge openings for sparging gas with the cathode plates. In known sparging systems it is quite difficult to ensure that the holes for discharging the sparging gas are properly aligned with the cathode plates.

The invention will now be further described with reference to the accompanying drawings, in which:

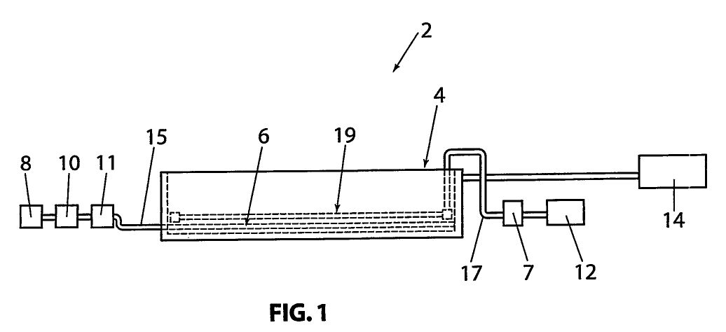

FIG. 1 is a schematic view of a copper electrowinning apparatus;

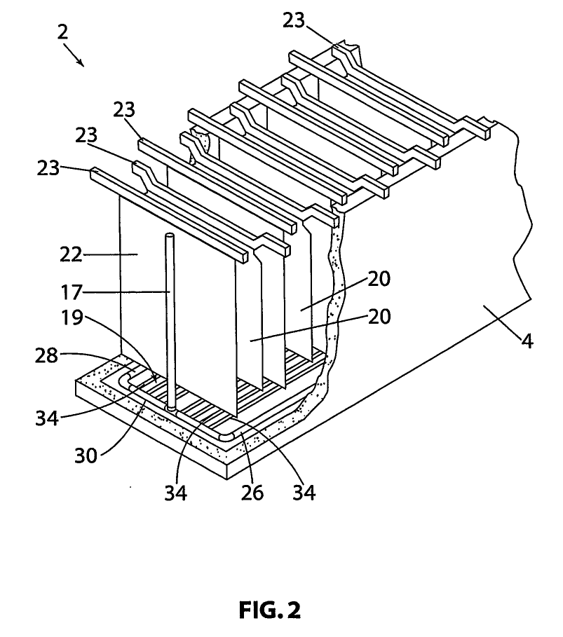

FIG. 2 is a fragmentary perspective view of an electrolytic cell;

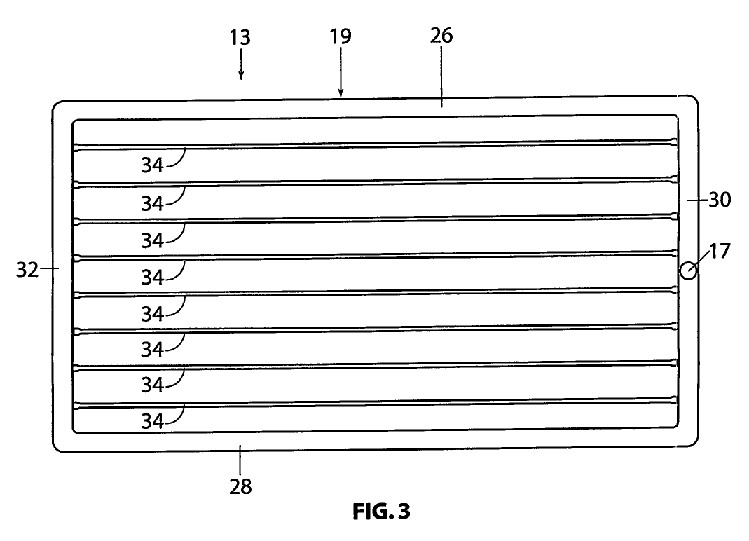

FIG. 3 is a schematic plan view of sparging apparatus of the invention; and

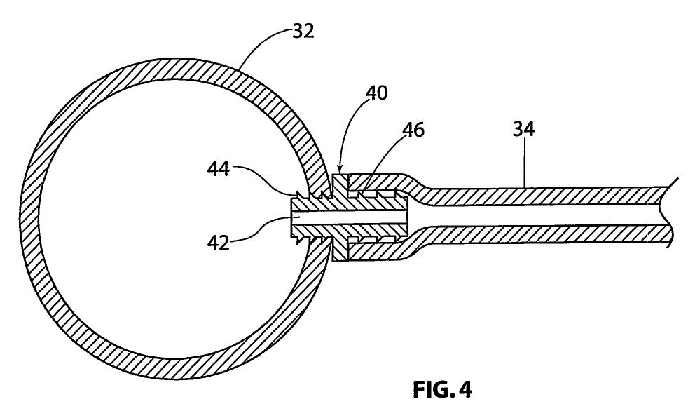

FIG. 4 is a cross-sectional view through a manifold in the sparging apparatus.

FIG. 1 diagrammatically illustrates copper electrowinning apparatus 2 including an electrolytic cell 4 having a manifold system 6 which is supplied with fresh electrolyte from a source 8 of fresh electrolyte by means of a pump 10. A filter 11 may be provided after the pump 10 in order to filter out any particulate matter of diameter greater than around 0.5 mm so as to avoid clogging of outlets in the manifold system 6. The filter 11 is located in an electrolyte supply line 15 which is connected to the manifold system 6. A sparging gas compressor 12 is arranged to deliver sparging gas at a predetermined flow rate to a sparging system 13 so that gas bubbles can be introduced into electrolyte in the cell 4. The sparging gas is preferably air. Spent electrolyte is collected in a spent electrolyte collector 14 for reprocessing or the like.

The sparging air generator 12 can be of known type and therefore need not be described in detail. It may comprise an air compressor which produces air having a pressure in the range 620−690 kPa but this pressure is reduced by means of a flow regulator valve (not shown) so that the air flow rate could be fixed with the help of a flow meter and a pressure sensor before being supplied to the manifold system 6. In order to reduce crystallisation growth in the manifold system 6 compressed air from the compressor 12 is humidified by means of a humidifier 7. Normally, the humidifier 7 humidifies the air so as to be saturated with water vapour. The amount of water vapour in the air depends on pressure and temperature, in the usual way. The humidifier is located in a sparging gas supply line 17 which is connected to the sparging system 13.

The cell 4 is schematically illustrated in fragmentary form in FIG. 2. The cell 4 includes a tank 16 which contains electrolyte (not shown). The manifold system 6 for delivering the fresh electrolyte to the cell has been omitted from FIG. 2 for clarity of illustration. The tank 16 includes a plurality of anodes 20 and cathodes 22 which are alternately disposed along the length of the cell. The anodes and cathodes are supported by electrode hanger bars 23 in the usual way. Preferably, the cathodes are in the form of flat cathode plates 24. Typically the cathode plates 24 are made from stainless steel plates say 3 mm in thickness and about 1 metre square in area. The spacing between cathode plates is typically of the order of 100 mm.

FIG. 3 diagrammatically shows in more detail the sparging system 13 of the invention. The sparging system 13 includes a sparging gas manifold 19 which is coupled to the sparging gas supply line 17. The manifold 19 includes two longitudinally extending lines 26 and 28 and transversely extending lines 30 and 32. The system 13 includes a plurality of microporous hoses 34 which are parallel to the lines 26 and 28 and have their ends connected to the transverse lines 30 and 32, as shown in FIG. 3. The arrangement is such that the sparging gas is supplied under pressure to the manifold 19 permitting the air to enter the interior of the hoses 34 from both ends thereof so that the air permeates therethrough at a relatively uniform rate. Typically, the apparatus includes eight of the hoses 34 which are appropriate for the electrode plate arrangement defined above. In one prototype apparatus, the hoses 34 were located approximately 150 mm from the bottom of the cell and at a level about 100 mm lower than the distribution manifold 6 which supplies fresh electrolyte to the cell. The lower edges of the cathode plates 24 are usually located at least 250 mm above the bottom of the cell 4 and it is preferred that the hoses 34 are located about midway between the bottom edges of the cathode plates and the bottom of the cell. It would be possible to include a protective grid (not shown) between the hoses 34 and the bottom edges of the cathode plates 24 in order to prevent inadvertent damage to the hoses when the cathode plates are being removed and replaced.

The hoses are preferably made from flexible material such as recycled rubber and/or other acid resistant material which is processed to have a porous wall structure. The outer diameter can be say about 10 mm and the internal diameter about 6 mm. Material of this type is commonly used in irrigation systems, both domestic and commercial, and is therefore readily available and cheap. The nose has port sizes on its surface in the range from 50 to 500 microns and more preferably in the range 150 to 350 microns. The average surface density of the pores is in the range from 20 to 50%. The average porosity of the hose is typically in the range from 15 to 50%.

It would be possible to use other microporous structures in order to generate the fine sparging gas bubbles required in the method and apparatus of the invention. For instance, rigid tubes of porous material are available. One such tube is made from sintered plastic particles of high density polyethylene. A commercial product of this type is available from Porex Technologies. The pore size of the sintered tube is typically in the range from 90 microns to 140 microns and the porosity of the material of the tube is in the range from 40% to 50%.

It would also be theoretically possible to use microporous tubes made from sintered metal. There could, however, be potential problems with the use of sintered metal tubes because of corrosion and/or because of their electrical conductivity. Accordingly, the use of microporous hoses which are of the type frequently used for agricultural purposes, such as those made by Fiskars, is preferred in the method and apparatus of the invention.

The manifold 19 may be made from any suitable material such as PVC pipe of cylindrical cross-section, as shown in FIG. 4. Preferably the manifold has the following dimensions: 50 mm diameter, around 6 metres length and around 1.2 metres separation.

The pressure and flow rate of the sparging gas depends on a number of factors including the depth of the electrolyte and the size and number of the electrode plates. In a prototype cell having sixty cathode plates 22 and sixty-one anode plates 20, air was supplied at a flow rate of about 100-200 litres per minute and at a pressure of about 50 to 100 kPa, the pressure being reduced from its initial pressure in the compressor. This was found to produce a substantial output of sparging gas bubbles emanating from the surfaces of the hoses 34. The average size of the sparging bubbles was estimated to be in the range from 1 mm to 3 mm in diameter as they leave the surface of the hoses 34. There may, however, be some smaller bubbles and, after leaving the surface of the hoses 34, some bubbles may coalesce into larger bubbles, some of which may be greater than say about 3 mm in diameter. The location of the hoses 34 beneath the manifold 6 which supplies the fresh electrode has the effect of causing transport of fresh electrolyte with the sparging gas bubbles towards the electrode plates. As a consequence, the mixing or disturbance in the cell causes disruption of a reduced copper ion concentration boundary layer which tends to form on the cathode plates 22 and fresh electrolyte is accordingly supplied to the cathode plates.

It will be appreciated that in the preferred embodiment of the invention, the eight hoses produce a generally uniform zone of fine sparging air bubbles which have the effect of causing fresh electrolyte to be supplied to the cathode plates 22, as described above. It will be appreciated that it is therefore unnecessary to align the hoses 34 with the cathode plates. This very much simplifies the installation process because in known sparging systems which had a fewer number of larger outlets for sparging gas, it was important and difficult to correctly align those openings with the location of the cathode plates.

The techniques of the invention permit operation of the cells at a current density of at least 280 amps per square metre. It is considered, however, that higher current densities will be achievable with the sparging apparatus and method of the invention, notwithstanding its simple and inexpensive construction.

As noted above, the pressure of the air supplied to the manifold is in the range from 50 kPa to 100 kPa. This pressure range is chosen so as to provide adequate pressure for production of sparging gas bubbles and to ensure that the distribution of the bubbles is generally uniform throughout the cell. It is preferred that the pressure drop across the hose wall is substantially less than the frictional pressure loss caused by air flowing within the hose. Accordingly a pressure drop across the wall of the hoses 34 which is at least one fifth of the internal pressure within the hose is appropriate. Typically, the pressure drop across the hose wall is about 5 kPa-10 kPa. Because the pressure drop across the wall of the hoses is significantly greater than the internal frictional losses, this tends to maintain a more uniform pressure distribution along the lengths of the hoses. It is also preferred that the pressure at the surface of the hoses is at least about 15 kPa in order to overcome the electrolyte head and to ensure reliable production of sparging gas bubbles.

In the sparging system of the invention, it is desirable to have the ability to monitor the system in order to detect any ruptures in the hoses 34 or breaks in the manifold 19 which would cause significant volumes of air to be bubbled through the electrolyte at a concentrated location. This would upset the relatively uniform generation of fine sparging air gas bubbles in the cell. It could also produce disturbance on the surface of the electrolyte which could contribute significantly to acid mist production. In the method and apparatus of the invention, it is a relatively straight forward matter to monitor for such ruptures. This can be carried out by monitoring the pressure in the manifold 19. If the pressure monitoring shows a substantial loss of pressure, this would indicate a rupture or leak in one or more of the hoses 34 or in the manifold 19. The monitoring system can be caused to generate an alarm and/or to stop or reduce supply of sparging air to the manifold.

As noted above, the flow rate of the sparging gas to the manifold 19 is typically about 100 to 200 litres per minute which is appropriate for the illustrated arrangement which has eight of the hoses 34 in the cell. It is preferred that the flow rate of the air is such that the discharge rate of sparging gas is in the range from 1 to 101/minute per metre of length of hose. More preferably, the range is 2 to 6 l/minute per metre of hose and most preferably about 3 l/minute per metre of hose.

FIG. 4 illustrates one way in which the ends of the hoses 34 are connected to the manifold line 30 or 32. In this arrangement, each of the ends of the hoses 34 is mounted on a stainless steel or plastic connector 40 having a bore 42 therethrough which permits flow of sparging air from the interior of the line 32 to the interior of the hose 34, as shown. The line 32 is formed with a hole into which can be mounted a threaded spigot 44 of the connector 40. The connector 40 includes a barbed spigot 46 on its opposite side which is received within the interior of the hose 34, as shown. A hose clamp (not shown) may be used if required to make the connection of the hoses more secure.

The cell may include a layer of buoyant plastic balls or the like which float on the surface of the electrolyte so as to suppress mist which tends to form as the sparging gas leaves the top of the cell. A surfactant may also be added to the electrolyte in order to further suppress production of acid mist. A suitable surfactant is FC1100 supplied by 3M. Further, the cell may include a hood and extraction system (not shown) for extraction of any mist which is produced. The mist could be treated in a scrubber before release to the atmosphere in order to minimise production of pollutants.

It will be appreciated by those skilled in the art that the use of sparging air gas bubbles of small sizes results in a number of significant advantages over previous proposals. It is thought that these advantages will enable for the first time tank houses to use sparging systems in an economic and less hazardous manner. The apparatus of the invention is robust because the hoses are inherently flexible. The hoses can also be readily replaced. Also, problems associated with clogging of outlet orifices for sparging gases is substantially eliminated because there are a multiplicity of pores on the surfaces of the hoses from which sparging gases emerge owing to their inherently porous nature.

It is possible that the sparging air can be intermittently supplied to the cell and still be effective. This is because depleted copper electrolyte boundary layers take time to be established and energy savings could be made by intermittently operating the air compressor. The flow rates of sparging air referred to hereinbefore are those applicable when the compressor is operating.

It is thought that the principles of the invention are applicable in other types of electrolytic cells such as those for electrowinning of nickel, cobalt, zinc or manganese.

Many modifications will be apparent to those skilled in the art without departing from the spirit and scope of the invention.

1. A method of operating an electrolytic cell including the steps of:
disposing sparging elements in electrolyte in the cell, the elements having a multiplicity of surface pores or openings therein; and
supplying sparging gas to the elements such that the elements form a multiplicity of fine sparging gas bubbles in the electrolyte.

2. A method of operating an electrolytic cell as claimed in claim 1 wherein the step of supplying the sparging gas includes the step of selecting the flow rate and pressure of the sparging gas such that the average size of the sparging gas bubbles is in the range from 1 mm to 3 mm.

3. A method of operating an electrolytic cell as claimed in any one of claims 1 or 2, wherein the cell includes anode and cathode plates and the elements are located beneath the plates.

4. A method of operating an electrolytic cell as claimed in any one of claims 1 to 3, wherein the elements are hoses which are made from or include microporous material.

5. A method of operating an electrolytic cell as claimed in claim 4 including the step of disposing a plurality of said hoses in the cell.

6. A method of operating an electrolytic cell as claimed in claim 5 including the step of controlling the pressure of the sparging gas to said hoses such that the discharge rate of sparging gas is in the range from 1 to 10 litres of gas per minute per metre of hose.

7. A method of operating an electrolytic cell as claimed in claim 6, wherein the step of controlling the pressure of the sparging gas is such that the discharge rate is in the range from 2 to 6 litres of gas per minute per metre of hose.

8. A method of operating an electrolytic cell as claimed in claim 7, wherein the step of controlling the pressure of the sparging gas is such that the discharge rate is about 3 litres of gas per minute per metre of hose.

9. A method of operating an electrolytic cell as claimed in any one of claims 4 to 8, wherein the pressure within the hoses is in the range 50 kPa to 100 kPa.

10. A method of operating an electrolytic cell as claimed in claim 9, wherein said step of controlling the pressure of the sparging gas to said hoses is such that the pressure within the hoses is at least 5 times the pressure drop across sidewalls thereof.

11. A method of operating an electrolytic cell as claimed in any one of claims 4 to 10, wherein the pressure of the sparging gas at the surface of the hoses is controlled to be at least 15 kPa above the pressure of the electrolyte surrounding the hoses.

12. A method of operating an electrolytic cell as claimed in any one of claims 4 to 11, wherein the microporous material has surface pore sizes in the range from 50 to 500 microns.

13. A method of operating an electrolytic cell as claimed in claim 12 wherein the microporous material has surface pore sizes in the range 150 to 350 microns.

14. A method of operating an electrolytic cell as claimed in claim 12 or 13 wherein the surface density of said pores is in the range 20 to 50%.

15. A method of operating an electrolytic cell as claimed in any one of claims 1 to 14 wherein the average porosity of said microporous material is in the range 15 to 50%.

16. A method of operating an electrolytic cell as claimed in any one of claims 1 to 15 including the steps of adding floating balls and/or a surfactant to the electrolyte in order to suppress mist from the cell.

17. A method of operating an electrolytic cell as claimed in claim 16 including the step of providing a hood above the cell to collect mist emanating therefrom.

18. A method of operating an electrolytic cell as claimed in any one of claims 1 to 17 wherein the electrolyte contains copper ions.

19. A method of operating an electrolytic cell as claimed in any one of claims 1 to 18 wherein the sparging gas is air.

20. A method of operating an electrolytic cell which includes a plurality of cathodes for deposition of copper thereon from an electrolyte in the cell, the method including the step of releasing sparging air bubbles beneath the cathodes characterised in that the majority of the air bubbles is in the size range from 1 mm to 3 mm.

21. A method of operating an electrolytic cell which includes a plurality of cathodes for deposition of copper thereon from an electrolyte in the cell, the method including the step of disposing a plurality of microporous hoses beneath the cathodes, supplying sparging gas to the hoses so that a zone of fine sparging gas bubbles is produced and permitting the fine sparging gas bubbles to rise in the electrolyte adjacent to the cathodes so that any depleted electrolyte adjacent to the cathodes is disturbed.

22. A method of operating an electrolytic cell as claimed in claim 21 wherein the cathodes are plates which are disposed in parallel relationship to one another and wherein the hoses extend in directions which are generally perpendicular to the planes of said plates.

23. Apparatus for sparging an electrolytic cell, the apparatus including an inlet manifold to which a sparging gas is delivered, a plurality of hoses, and coupling means for coupling at least one end of each of the hoses to the manifold, characterised in that the hoses are made from or include microporous material which permits, in use, the sparging gas to pass therethrough so as to form a multiplicity of fine bubbles in the electrolyte in the cell.

24. Apparatus for sparging an electrolytic cell, the apparatus including an inlet manifold to which a sparging gas is delivered, a plurality of sparging gas discharge elements, and coupling means for coupling at least one end of each of the elements to the manifold, characterised in that the elements are made from or includes microporous material which permits, in use, the sparging gas to pass therethrough so as to form a multiplicity of fine bubbles in the electrolyte in the cell.

25. Apparatus as claimed in claim 24 wherein the sparging gas discharge elements comprise flexible hoses made from rubber.

26. Apparatus as claimed in claim 23 or 25 wherein the hoses have surface pores, the average size of which are in the range from 50 to 500 microns.

27. Apparatus as claimed in claim 26 wherein the hoses have surface pores the average size of which are in the range from 150 to 350 microns.

28. Apparatus as claimed in claim 26 wherein the surface density of the pores on the hoses is in the range from 20 to 50%.

29. Apparatus as claimed in any one of claims 23 to 28 wherein the porosity of the hoses is in the range from 15 to 50%.

30. An electrolytic cell for electrowinning of copper, the cell including:
a plurality of alternately disposed anode and cathode plates in the cell;
an electrolyte containing copper ions in the cell;
a sparging gas manifold located beneath the cathode plates;
sparging gas supply means for supplying sparging gas to said manifold; and
wherein the manifold includes microporous material which permits, in use, the sparging gas to pass therethrough so as to form a multiplicity of fine bubbles in the electrolyte.

31. A method of operating an electrolytic cell as claimed in any one of claims 1 to 16 wherein the electrolyte contains nickel ions, cobalt ions, zinc ions, or manganese ions.
